(19) United States
(12) Patent Application Publication
(10) Pub. No.: US 2012/0110317 A1
(43) Pub. Date: May 3, 2012

(54) CONTENT DOWNLOAD MANAGER

(75) Inventors: Fred SCHEER, Bradford, MA (US); Diego S. Rozensztejn, Brighton, MA (US); Gaurav Mehta, Brookline, MA (US); Jack Jianxiu Hao, Lexington, MA (US)

(73) Assignee: Verizon Patent and Licensing Inc., Basking Ridge, NJ (US)

(21) Appl. No.: 12/915,434

(22) Filed: Oct. 29, 2010

(51) Int. Cl. G06F 15/16; G06F 21/00; H04L 9/32; G06F 3/01; H04L 9/00

(52) U.S. Cl. 713/150; 709/232; 715/738; 726/28

(57) ABSTRACT

A system is configured to receive input to define one or more download policies from a group of available download policies, including one or more network restriction policies, one or more time restriction policies, one or more event restriction policies, and one or more location restriction policies. The system is further configured to receive an instruction to download particular content, determine that the one or more download policies permit the particular content to be downloaded, download the particular content when the one or more download policies permit the particular content to be downloaded, and generate a notification that the particular content is available to be accessed.

### BACKGROUND

Content providers, such as wireless telephone service providers, permit users to obtain multimedia content on their mobile devices. Download processes, for downloading content onto a user's mobile device, can sometimes be cumbersome and inconvenient to the user.

### BRIEF DESCRIPTION OF THE DRAWINGS

FIG. 1 is a diagram of an overview of an implementation described herein;

FIG. 2 is a diagram that illustrates an example environment in which systems and/or methods, described herein, may be implemented;

FIG. 3 is a diagram of example components of a device that may be used within the environment of FIG. 2;

FIG. 4 is a diagram of an example mobile device of FIG. 2;

FIG. 5 is a diagram of example components of the mobile device of FIG. 4;

FIG. 6 is a diagram of example functional components of the mobile device of FIG. 4;

FIG. 7 is a diagram of an example user interface via which download policies may be specified;

FIG. 8 is a flowchart of an example process for obtaining video content;

FIGS. 9A-9D illustrate example user interfaces that may be presented during the downloading of video content;

FIG. 10 is a flowchart of an example process for specifying download policies; and

FIGS. 11 and 12 illustrate a flowchart of an example process for downloading video content.

### DETAILED DESCRIPTION OF PREFERRED EMBODIMENTS

The following detailed description refers to the accompanying drawings. The same reference numbers in different drawings may identify the same or similar elements.

An implementation, described herein, may use one or more download policies to determine when and how video content is downloaded to a mobile device. The download policies may be set, by a user of the mobile device, to download video content in a manner that is beneficial and convenient to the user. For example, the download policies may save bandwidth, time, or cost associated with the video content download.

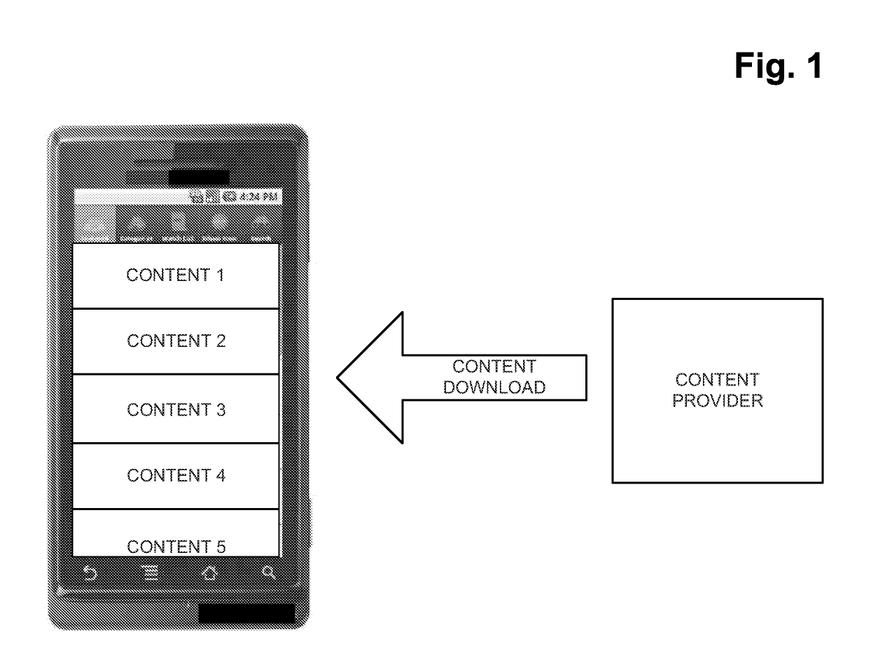

FIG. 1 is a diagram of an overview of an implementation described herein. As shown in FIG. 1, a user of a mobile device may use the mobile device to request and obtain content. For example, the user may access a list of available items of content and select one of the items for downloading to the mobile device. In response to selection of an item of content, the mobile device may download the item of content according to a set of download policies established by the user. The set of download policies may specify a network restriction, a time restriction, an event restriction, a location restriction, or a combination of restrictions.

The network restriction may specify a user's preference for a type of network connection for a download operation. For example, the network restriction might identify a particular type of network connection to use, a preference for one type of network connection over another, etc. The time restriction may specify a user's preference for a time at which to commence a download operation. For example, the time restriction might identify a time of day, a day of week, a time period (e.g., between 11 pm and 6 am), etc. The event restriction may specify a user's preference for the occurrence of a particular event before commencing a download operation. For example, the event restriction might identify a particular event that needs to occur before initiating a download operation (e.g., download when the mobile device is plugged in for recharging, download when the mobile device is idle for at least thirty minutes, etc.). The location restriction may specify a user's preference for a particular geographic location or geographic region for a download operation. For example, the location restriction might identify a particular geographic location (e.g., at home) or a particular geographic region (e.g., the Washington metro area) in which to initiate a download operation.

Once the content has been downloaded to the mobile device, the mobile device may obtain the necessary license information. The content may, thereafter, be available to the user for playing.

The description to follow will describe the content as video content, such as television content, movie content, gaming content, or the like. The term “video content,” as used herein, is intended to include video data, which may or may not be combined with audio data. While the description will focus on video content, the description is not so limited and may apply to other types of content, such as audio content (e.g., audio books, music, concerts, etc.).

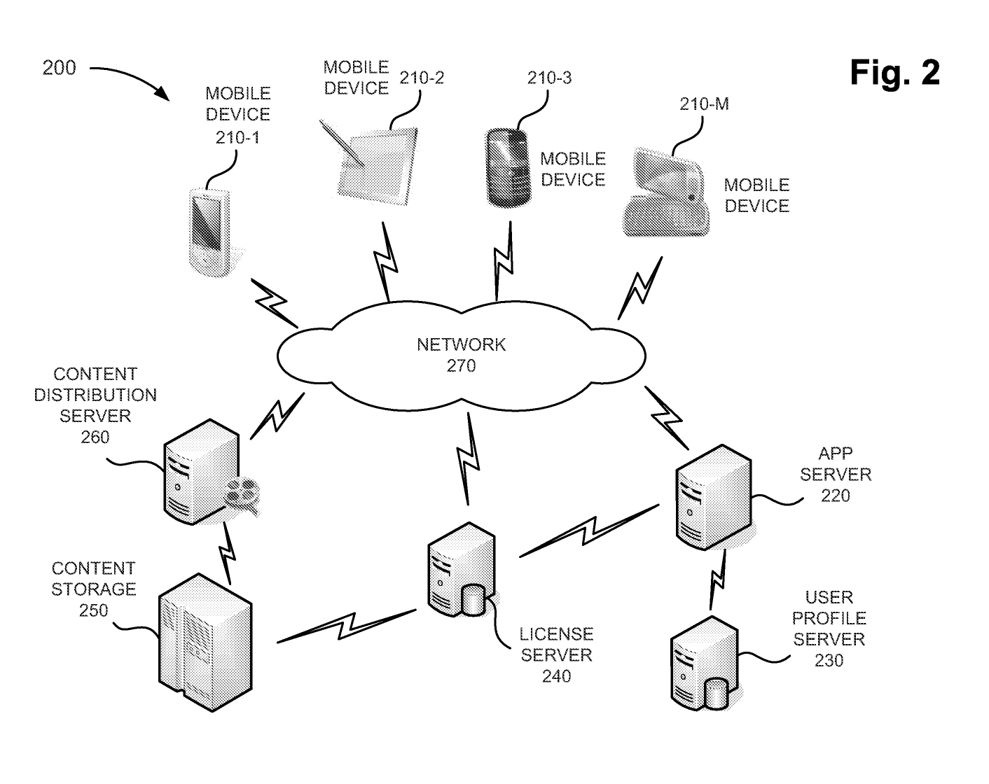

FIG. 2 is a diagram that illustrates an example environment 200 in which systems and/or methods, described herein, may be implemented. As shown in FIG. 2, environment 200 may include mobile devices 210-1, 210-2, . . . , 210-M (where M≧1) (collectively referred to as “mobile devices 210,” and individually as “mobile device 210”), an application server 220 (hereinafter referred to as “app server 220”), a user profile server 230, a license server 240, content storage 250, a content distribution server 260, and a network 270. While FIG. 2 shows a particular number and arrangement of devices, in practice, environment 200 may include additional, fewer, different, or differently arranged devices than are shown in FIG. 2. For example, each of servers 220-240 or 260 may be implemented as multiple, possibly distributed, devices. Alternatively, two or more of servers 220-240 and 260 may be implemented within a single device.

Mobile device 210 may include any portable device capable of communicating via a network, such as network 270. For example, mobile device 210 may correspond to a mobile communication device (e.g., a mobile phone or a personal digital assistant (PDA)), a portable computer device (e.g., a laptop or a tablet computer), or another type of portable device.

App server 220 may include a server device, such as a computer device, that provides a video content application or performs user authentication, content listing management, or order processing. For example, app server 220 may permit mobile device 210 to download a video content application that may permit a user to find video content of interest or play downloaded or streaming video content. Also, or alternatively, app server 220 may provide video content metadata, such as lists or categories of video content. Also, or alternatively, app server 220 may authenticate a user who desires to purchase, rent, or subscribe to video content. In one implementation, the interactions between app server 220 and mobile device 210 may be performed using the hypertext transfer protocol (HTTP) or the secure HTTP (HTTPS). In another implementation, the interactions between app server 220 and mobile device 210 may be performed using another type of protocol.

User profile server 230 may include a server device, such as a computer device, that stores user profile information for users. The user profile information may include various information regarding a user, such as login information (e.g., user identifier and password), billing information, address information, types of services to which the user has subscribed, a list of video content purchased by the user, a list of video content rented by the user, a list of video content to which the user has subscribed, ratings of video content by the user, a device identifier (e.g., a mobile device identifier, a set top box identifier, a personal computer identifier) for devices used by the user, a video content application identifier associated with the video content application obtained from app server 220, or the like. App server 220 may use the user profile information to authenticate a user and may update the user profile information based on the user's activity (with the user's express permission).

License server 240 may include a server device, such as a computer device, that provides key and license management. For example, license server 240 may receive a request from a mobile device 210 for a license relating to video content that mobile device 210 has downloaded. The license may include information regarding the type of use permitted by mobile device 210 (e.g., a purchase, a rental, or a subscription) and a decryption key that permits mobile device 210 to decrypt the video content. In one implementation, the communication between license server 240 and mobile device 210 may be conducted over a secure channel, may include public and private keys, or may include other forms of secure communication.

Content storage 250 may include a server device, such as a computer device, or a storage device, such as a database, that stores or processes video content. For example, content storage 250 may perform encoding operations on video content using, for example, public/private keys. Content storage 250 may also perform transcoding operations on the video content. Content storage 250 may store video content in encrypted form.

Content distribution server 260 may include a server device, such as a computer device, that delivers video content to mobile devices 210. For example, content distribution server 260 may permit a mobile device 210 to download particular video content once the user, of mobile device 210, has been properly authenticated. In one implementation, the downloading of video content may occur using the file transfer protocol (FTP). In another implementation, the downloading of video content may occur using another type of protocol.

Network 270 may include any type of network or a combination of networks. For example, network 270 may include a local area network (LAN), a wide area network (WAN) (e.g., the Internet), a metropolitan area network (MAN), an ad hoc network, a telephone network (e.g., a Public Switched Telephone Network (PSTN), a cellular network, or a voice-over-IP (VoIP) network), or a combination of networks. In one implementation, mobile device 210 may download video content via a wireless LAN (WLAN) (e.g., Wi-Fi (wireless fidelity)), a wireless WAN (WWAN) (e.g., EVDO (evolution data optimized)), sideloading (i.e., a transfer between two local devices), or a cable (e.g., USB).

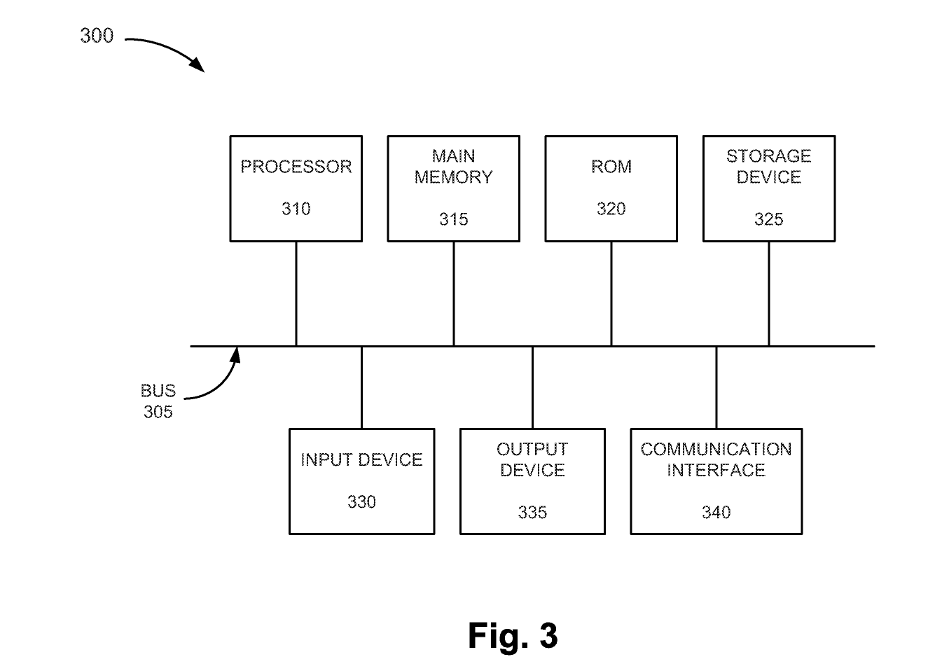

FIG. 3 is a diagram of example components of a device 300. Device 300 may correspond to app server 220, user profile server 230, license server 240, content storage 250, or content distribution server 260. Each of app server 220, user profile server 230, license server 240, content storage 250, and content distribution server 260 may include one or more devices 300.

As shown in FIG. 3, device 300 may include a bus 305, a processor 310, a main memory 315, a read only memory (ROM) 320, a storage device 325, an input device 330, an output device 335, and a communication interface 340. In another implementation, device 300 may include additional, fewer, different, or differently arranged components.

Bus 305 may include a path that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a mechanism that permits an operator to input information to device 300, such as a control button, a keyboard, a keypad, or another type of input device. Output device 335 may include a mechanism that outputs information to the operator, such as a light emitting diode (LED), a display, or another type of output device. Communication interface 340 may include any transceiver-like mechanism that enables device 300 to communicate with other devices (e.g., mobile devices 210) or networks (e.g., network 270). In one implementation, communication interface 340 may include a wireless interface, a wired interface, or an optical interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include space within a single physical memory device or spread across multiple physical memory devices.

The software instructions may be read into main memory 315 from another computer-readable medium, such as storage device 325, or from another device via communication interface 340. The software instructions contained in main memory 315 may cause processor 310 to perform processes that will be described later. Alternatively, hardwired circuitry may be used in place of or in combination with software instructions to implement processes described herein. Thus, implementations described herein are not limited to any specific combination of hardware circuitry and software.

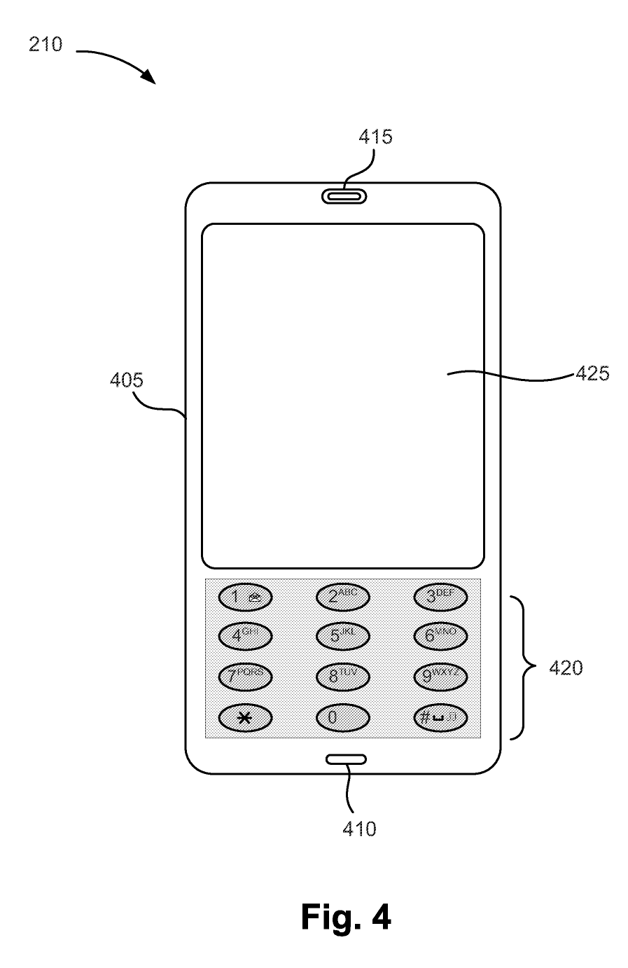

FIG. 4 is a diagram of an example implementation of mobile device 210. In the implementation shown in FIG. 4, mobile device 210 may correspond to a mobile communication device. Mobile device 210 may include a housing 405, a microphone 410, a speaker 415, a keypad 420, and a display 425. In other implementations, mobile device 210 may include fewer, additional, different, or differently arranged components than those illustrated in FIG. 4 and described herein. For example, keypad 420 may be implemented on a touch screen of display 425.

Housing 405 may include a structure to contain components of mobile device 210. For example, housing 405 may be formed from plastic, metal, or some other material. Housing 405 may support microphone 410, speaker 415, keypad 420, and display 425.

Microphone 410 may include an input device that converts a sound wave to a corresponding electrical signal. For example, the user may speak into microphone 410 during a telephone call or to execute a voice command. Speaker 415 may include an output device that converts an electrical signal to a corresponding sound wave. For example, the user may listen to music, listen to a calling party, or listen to other auditory signals through speaker 415.

Keypad 420 may include an input device that provides input into mobile device 210. Keypad 420 may include a standard telephone keypad, a QWERTY keyboard, or some other type or arrangement of keys. Keypad 420 may also, or alternatively, include one or more special purpose keys. The user may utilize keypad 420 as an input component to mobile device 210. For example, the user may use keypad 420 to enter information, such as alphanumeric text, to access data, or to invoke a function or an operation. As described above, keypad 420 may be implemented not as physical keys, but rather as virtual keys on a touch screen of display 425.

Display 425 may include an output device that outputs visual content, and/or may include an input device that receives user input (e.g., a touch screen (also known as a touch display)). Display 425 may be implemented according to a variety of display technologies, including but not limited to, a liquid crystal display (LCD), a plasma display panel (PDP), a field emission display (FED), a thin film transistor (TFT) display, or some other type of display technology. Additionally, display 425 may be implemented according to a variety of sensing technologies, including but not limited to, capacitive sensing, surface acoustic wave sensing, resistive sensing, optical sensing, pressure sensing, infrared sensing, gesture sensing, etc. Display 425 may be implemented as a single-point input device (e.g., capable of sensing a single touch or point of contact) or a multipoint input device (e.g., capable of sensing multiple touches or points of contact that occur at substantially the same time).

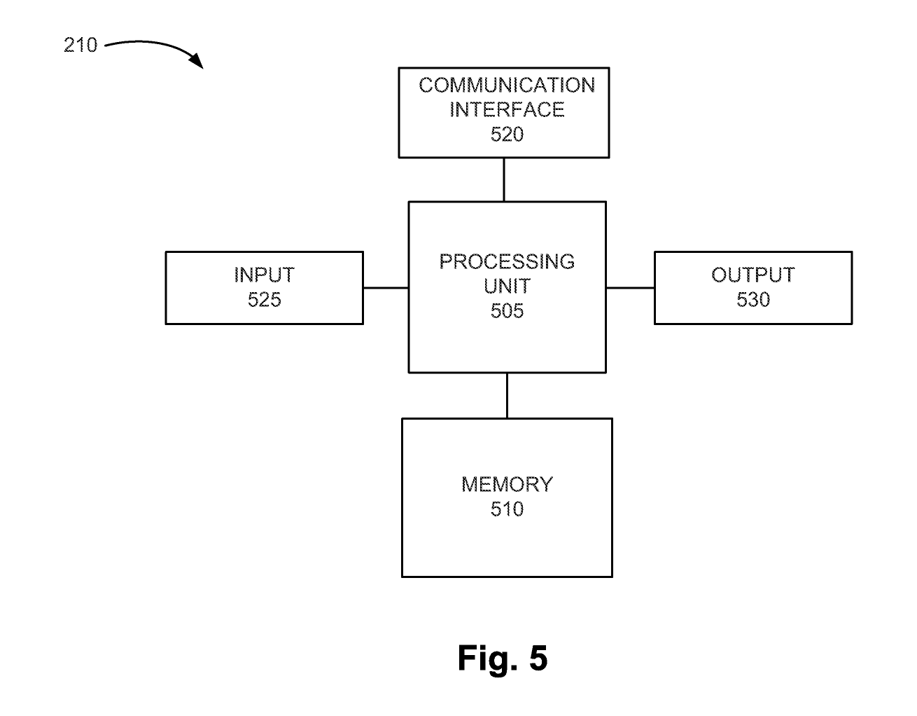

FIG. 5 is a diagram illustrating example components of mobile device 210. As illustrated, mobile device 210 may include a processing unit 505, a memory 510, a communication interface 520, an input component 525, and an output component 530. In another implementation, mobile device 210 may include fewer, additional, different, or differently arranged components than those illustrated in FIG. 5. Additionally, in other implementations, a function described as being performed by a particular component of mobile device 210 may be performed by a different component of mobile device 210.

Processing unit 505 may include one or more processors, microprocessors, data processors, co-processors, network processors, ASICs, controllers, programmable logic devices (PLDs), chipsets, FPGAs, or other components that may interpret or execute instructions or data. Processing unit 505 may control the overall operation, or a portion thereof, of mobile device 210, based on, for example, an operating system (not illustrated) and/or various applications. Processing unit 505 may access instructions from memory 510, from other components of mobile device 210, or from a source external to mobile device 210 (e.g., a network or another device).

Memory 510 may include memory or secondary storage. For example, memory 510 may include a RAM, a dynamic RAM (DRAM), a ROM, a programmable ROM (PROM), a flash memory, or some other type of memory. Memory 510 may include a hard disk (e.g., a magnetic disk, an optical disk, a magneto-optic disk, a solid state disk, etc.) or some other type of computer-readable medium, along with a corresponding drive. Memory 510 may store data, applications, or instructions related to the operation of mobile device 210. For example, memory 510 may include a variety of applications, such as a video content application, a navigation application, an e-mail application, a telephone application, a camera application, a voice recognition application, a multi-media application, a music player application, a visual voicemail application, a contacts application, a data organizer application, a calendar application, an instant messaging application, a texting application, a web browsing application, a blogging application, or other types of applications (e.g., a word processing application, a spreadsheet application, etc.). As described above, the video content application may permit a user to find video content of interest; purchase, rent, or subscribe to the video content; or play the video content.

Communication interface 520 may include a component that permits mobile device 210 to communicate with other devices (e.g., app server 220, license server 240, and content distribution server 260) or networks (e.g., network 270). For example, communication interface 520 may include some type of wireless or wired interface. Communication interface 520 may also include an antenna (or a set of antennas) that permit wireless communication, such as the transmission and reception of radio frequency (RF) signals.

Input component 525 may include a component that permits a user or another device to input information into mobile device 210. For example, input component 525 may include a keypad (e.g., keypad 420), a button, a switch, a knob, fingerprint recognition logic, retinal scan logic, a web cam, voice recognition logic, a touchpad, an input port, a microphone (e.g., microphone 410), a display (e.g., display 425), or some other type of input component. Output component 530 may include a component that permits mobile device 210 to output information to the user or another device. For example, output component 530 may include a display (e.g., display 425), LEDs, an output port, a speaker (e.g., speaker 415), or some other type of output component.

As described herein, mobile device 210 may perform certain operations in response to processing unit 505 executing software instructions contained in a computer-readable medium, such as memory 510. The software instructions may be read into memory 510 from another computer-readable medium or from another device via communication interface 520. The software instructions contained in memory 510 may cause processing unit 505 to perform processes described herein. Alternatively, hardwired circuitry may be used in place of or in combination with software instructions to implement processes described herein. Thus, implementations described herein are not limited to any specific combination of hardware circuitry and software.

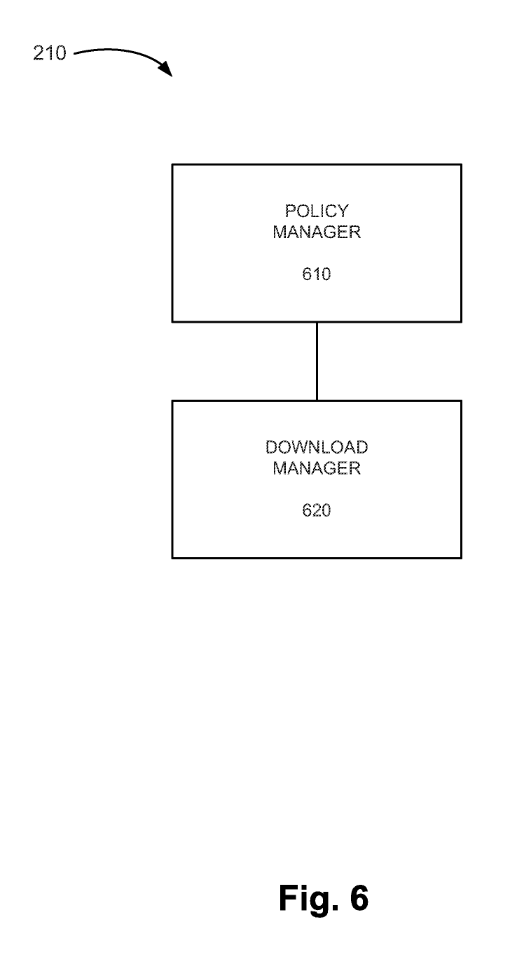

FIG. 6 is a diagram of example functional components of mobile device 210. As illustrated in FIG. 6, mobile device 210 may include a policy manager 610 and a download manager 620. Policy manager 610 and download manager 620 may be implemented as a combination of hardware and software based on the components illustrated and described with respect to FIG. 5. Alternatively, policy manager 610 and download manager 620 may be implemented as hardware based on the components illustrated and described with respect to FIG. 5.

Policy manager 610 may permit a user to specify a set of download policies upon which mobile device 210 may operate for downloading video content. The set of download policies may reflect the timing or manner in which video content is downloaded onto mobile device 210. As described above, in one implementation, the set of download policies may specify a network restriction, a time restriction, an event restriction, a location restriction, or a combination of restrictions.

The network restriction may specify a user's preference for a type of network connection for a download operation. For example, the network restriction might identify a particular type of network connection to use, such as only or never use WLAN, only or never use WWAN, only or never use sideloading, only or never use a cable, etc. Alternatively, the network restriction might identify a preference for one type of network connection over another. For example, the user might specify a priority for different types of network connections, such as use WLAN over WWAN and never use sideloading or cable; use cable if connected, then use sideloading if available, then use WLAN, and finally use WWAN; or another preference for different types of network connections.

The time restriction may specify a user's preference for a time at which to commence a download operation. For example, the time restriction might identify a time of day (e.g., 12 am); a day of week (e.g., Saturdays, weekends, weekdays, Tuesdays and Thursdays, etc.); or a time period (e.g., between 11 pm and 6 am). The time restriction can identify any combination of times, such as perform downloading on Fridays between 1 am and 6 am, on Saturdays between 11 pm and 5 am, and anytime on Sundays.

The event restriction may specify a user's preference for the occurrence of a particular event before commencing a download operation. For example, the event restriction might identify the particular event as recharging of mobile device 210 (e.g., download when mobile device 210 is plugged in for recharging). Alternatively, or additionally, the event restriction might identify a preference for downloading to commence when mobile device 210 is idle for a particular amount of time (e.g., when mobile device 210 is idle for at least thirty minutes). The event restriction might identify a combination of events, such as start downloading when mobile device 210 is plugged in for recharging and mobile device 210 is idle for at least sixty minutes. The term “idle,” as used herein, may refer to an instance when mobile device 210 is not being used at all, or may refer to an instance when mobile device 210 is not using a communication channel (e.g., not downloading content, not engaged in a telephone call, not accessing the Internet, etc.) but may be used for local operations.

The location restriction may specify a user's preference for a particular geographic location or geographic region for a download operation. For example, the location restriction might indicate that download operations are to occur at a particular geographic location, such as “my home,” “my vacation house,” etc. Alternatively, or additionally, the location restriction might indicate that download operations are to occur within a particular geographic region, such as in the Washington metro area, in Fairfax, Va., etc. The location restriction might identify a combination of geographic locations or geographic regions, such as start downloading when mobile device 210 is located in my home or when mobile device 210 is located in Raleigh, N.C. The location restriction might identify a combination of a geographic location/region and a time factor, such as start downloading when mobile device 210 has been at home for at least two hours. Mobile device 210 may use location-identifying techniques to determine its location, such as global positioning system (GPS) techniques, global navigation satellite system (GNSS) techniques, triangulation techniques, etc.

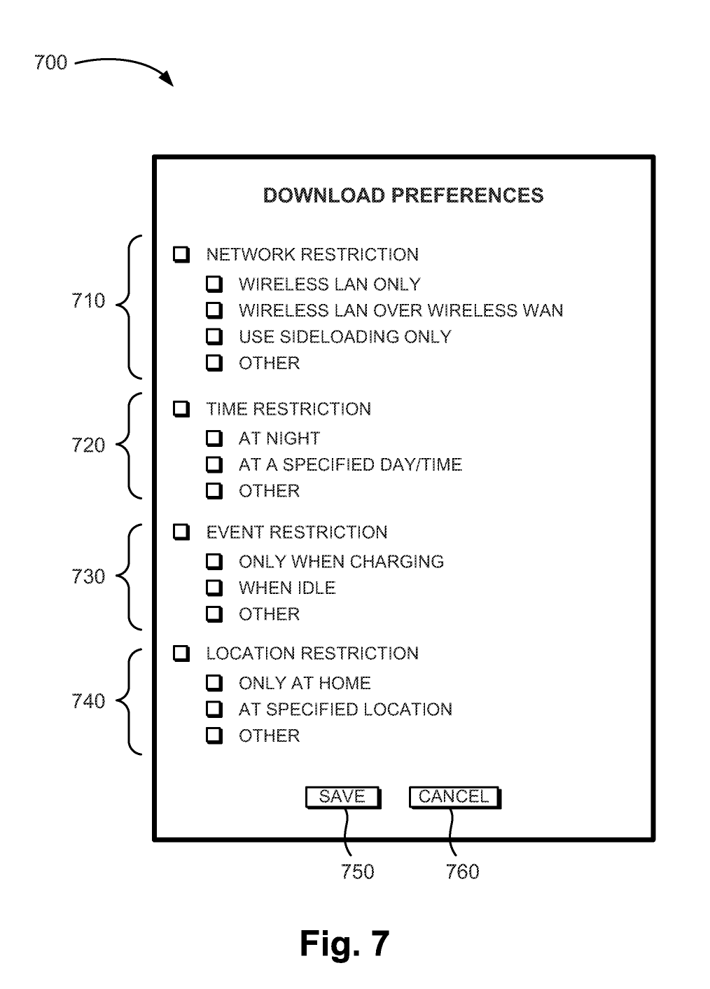

Policy manager 610 may present the user with a user interface via which the user can specify the download policies, if any, that the user desires. If the user does not select any download policies, either no download policies are used or a set of default download policies are used. FIG. 7 is a diagram of an example user interface 700 via which download policies may be specified. User interface 700 may be presented on display 425 of mobile device 210.

As shown in FIG. 7, user interface 700 may include a network restriction area 710, a time restriction area 720, an event restriction area 730, and a location restriction area 740. A user, of mobile device 210, may specify the user's preferences for the downloading operation by selecting particular items within areas 710-740. Selection of an item, within an area 710-740, might cause the item to be marked as selected or may cause an additional user interface to be presented for entry of additional information. For example, selection of the “when idle” item, within event restriction area 730, may cause an additional user interface to be presented for entry of the amount of idle time that would trigger a download operation. As another example, selection of the “at specified location” item, may cause another user interface, such as a map to be presented from which the user can select or enter a location.

Once the user has specified the set of download policies, the user may save the download policies by selecting a save button 750. Alternatively, if the user is not satisfied with the download policies the user has specified, the user may cancel the selections by selecting a cancel button 760.

Returning to FIG. 6, download manager 620 may perform a download operation based on the set of download policies stored by policy manager 610. Download manager 620 may determine how and when to commence a download operation based on the set of download policies. Download manager 620 may permit the user to override the set of download policies at any time.

Download manager 620 may manage a download operation. For example, download manager 620 may communicate with content distribution server 260 to obtain video content. Download manager 620 may monitor a progress of the download operation. Download manager 620 may also interrupt a download operation if mobile device 210 becomes involved in an operation that requires use of a communication channel, such a telephone call, access of the Internet, or the like. If a download operation is interrupted, download manager 620 may record the progress of the download operation so that when the download operation resumes, the download operation can begin where the download operation left off.

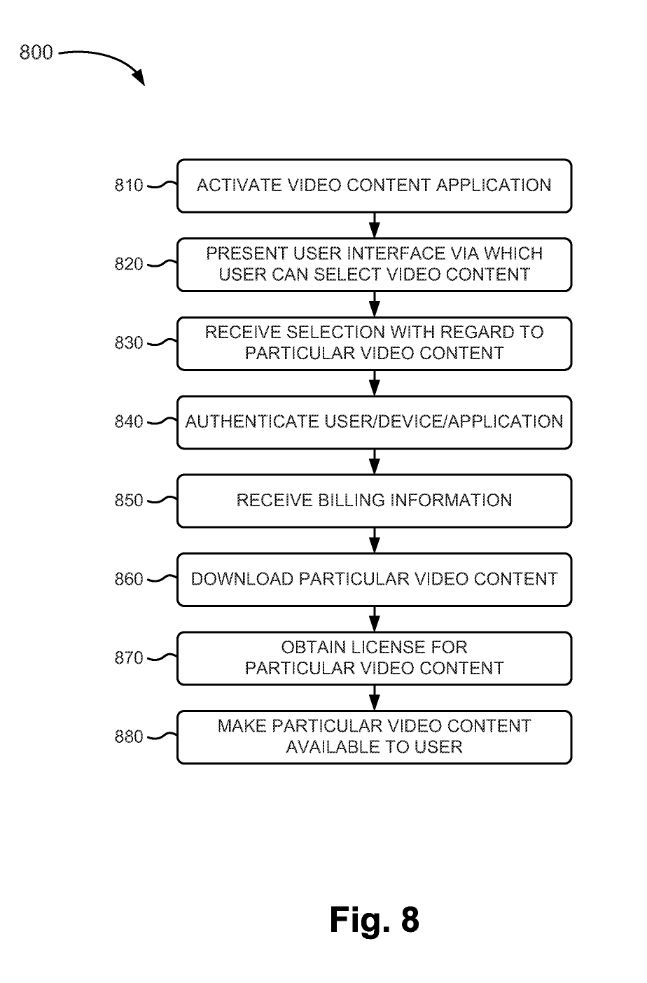

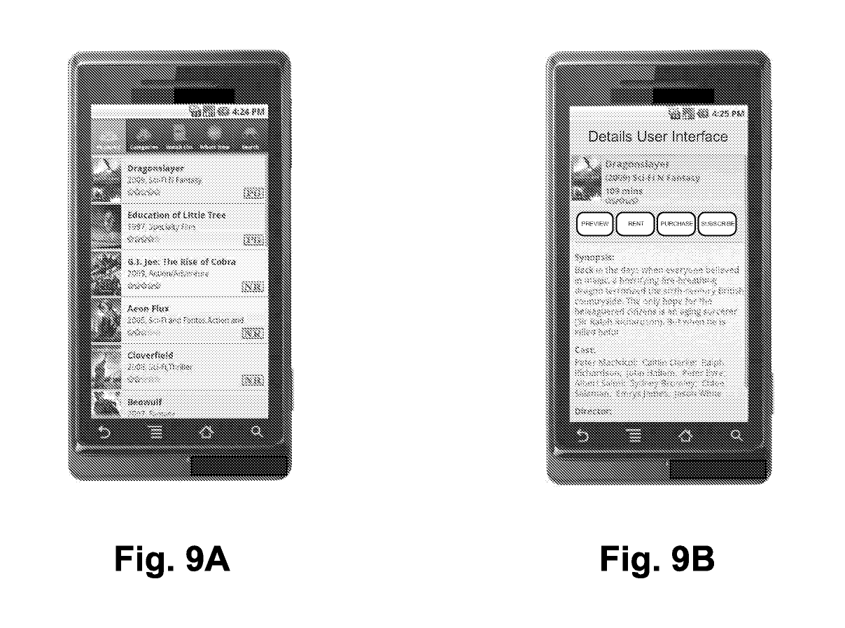

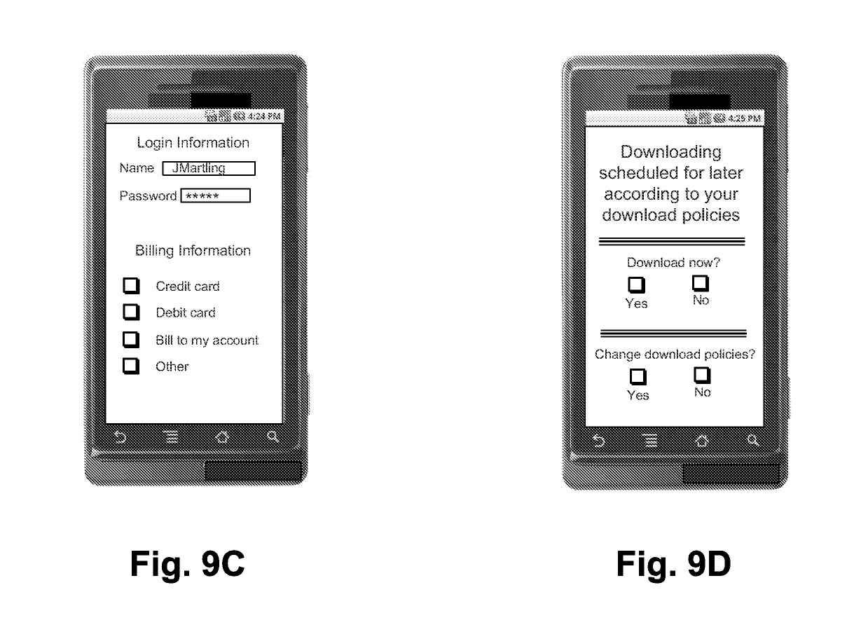

FIG. 8 is a flowchart of an example process 800 for obtaining video content. In one implementation, process 800 may be performed by one or more components of mobile device 210, such as processing unit 505 of mobile device 210. In another implementation, one or more blocks of process 800 may be performed by one or more components of another device (e.g., one or more of servers 220, 240, or 260), or a group of devices including or excluding mobile device 210. Process 800 will be described with corresponding references to example user interfaces illustrated in FIGS. 9A-9D.

Process 800 may include activating video content application (block 810). For example, a user, of mobile device 210, may activate a video content application in a standard manner, such as by selecting an icon (or another type of identifier) associated with the video content application, selecting the name of the video content application from a list, etc.

A user interface may be presented via which the user can select video content (block 820). For example, the video content application may provide information regarding available video content in a number of different formats. As shown in FIG. 9A, for example, the video content application may include an option that permits the user to access “featured” video content, an option that permits the user to access a list of categories of video content, an option that permits the user to access a watch list, an option that permits the user to access a “what's new” list, and an option that permits the user to search for video content. The “featured” video content option, when selected, may present a list of popular video content (e.g., popular to the user based on the user's prior purchases, rentals, subscriptions, or ratings, or popular to a group of users based on recent activity of the group of users, based on ratings by the group of users, etc.), video content that is being promoted, or simply available video content. The categories option, when selected, may permit the user to peruse video content by category, such as horror, drama, comedy, R-rated, G-rated, 5-star-rated, 4-star-rated, or other categories of video content. The watch list option, when selected, may present a list of video content that has been previously added to the watch list by the user or that is recommended to the user based on video content in which the user has expressed an interest (e.g., as determined by the user's prior activity). The “what's new” option, when selected, may present a list of video content that has recently become available. The search option, when selected, may permit the user to search for video content by keyword.

Returning to FIG. 8, a selection, with regard to particular video content, may be received (block 730). For example, the video content application may receive selection, by the user, of particular video content from within the presented user interface. In response to the selection by the user, the video content application may present a details user interface relating to the particular video content. The details user interface may include detailed information regarding the particular video content and options for acting upon the particular video content. The detailed information might include information, such as a title of the particular video content, a release date of the particular video content (e.g., a year that the particular video content was released), a category of the particular video content (e.g., a list of one or more categories assigned to the particular video content), a length of the particular video content (e.g., a running length of the particular video content), a rating of the particular video content (assigned by the user or by a group of users), a synopsis of the particular video content, a cast list for the particular video content, a director list for the particular video content, or the like.

The details user interface may also present the user with options to perform an action in relation to the particular video content. For example, the options might include an option to add the particular video content to the watch list, an option to preview the particular video content, an option to rent the particular video content, an option to purchase the particular video content, and an option to subscribe to a service relating to the particular video content. The option to add the particular video content to the watch list, when selected, may add the particular video content to the user's watch list. The option to preview the particular video content, when selected, may cause a trailer, or the like, to be played for the user. The option to rent the particular video content, when selected, may permit the user to access the particular video content for a particular rental period, after which the user may no longer be permitted to access the particular video content. The option to purchase the particular video content, when selected, may permit the user to own the particular video content. The option to subscribe to a service relating to the particular video content, when selected, may permit the user to subscribe to a service via which the particular video content is available. For example, the service relating to the particular video content may correspond to a pay service, such as HBO, Cinemax, Starz, the Howard Stern channel, the NFL RedZone channel, or the like. Once the user subscribes to the service, the particular video content may be available to the user for the subscription period or until the user terminates the subscription.

As shown in FIG. 9A, for example, assume that the user selects the video content entitled “Dragonslayer.” As shown in FIG. 9B, a details user interface may be presented with information regarding the video content entitled “Dragonslayer.” As further shown in FIG. 9B, the details user interface may permit the user to preview the video content, rent the video content, purchase the video content, or subscribe to a channel relating to the video content. Assume, for this example, that the user has selected to either the rent, purchase, or subscribe option.

Returning to FIG. 8, the user, device, or application may be authenticated (block 840). For example, the video content application may interact with app server 220 to authenticate the user, mobile device 210, or the video content application. For example, the video content application may solicit user login information (e.g., a user identifier (username) and password) from the user, as shown in FIG. 9C. The video content application may provide the user login information to app server 220. App server 220 may compare the user login information to information maintained by user profile server 230 and may authenticate the user when the information matches. Additionally, or alternatively, the video content application may provide device information (e.g., a mobile device identifier) to app server 220. App server 220 may compare the device information to information maintained by user profile server 230 and may authenticate mobile device 210 when the information matches. Additionally, or alternatively, the video content application may provide application information (e.g., an identifier associated with the video content application) to app server 220. App server 220 may compare the application information to information maintained by user profile server 230 and may authenticate the video content application when the information matches.

Billing information may be received (block 850). For example, the video content application may solicit the user to provide billing information, as shown in FIG. 9C. In one implementation, the user may provide credit or debit card information. In another implementation, the user may be permitted to simply add the expense (for the rental, purchase, or subscription) to the user's account with that service provider. In yet another implementation, the user may be permitted to use a payment service, such as PayPal.

Once the user, device, or application has been properly authenticated and billing information has been received, the particular video content may be downloaded (block 860). For example, the video content application may receive, from app server 220, a link (or the like) for requesting the particular content from content distribution server 260. The video content application may follow the link and interact with content distribution server 260 to download the particular video content. Content distribution server 260 may communicate with content storage 250 to obtain the particular video content, in encrypted form, that may then be delivered to mobile device 210. Content distribution server 260 or content storage 250 may communicate with license server 240 to obtain a license identifier corresponding to a license associated with the particular video content. Content distribution server 260 may provide the particular video content and the license identifier to the video content application. The video content application may store the downloaded particular video content, and possibly the license identifier, in a memory associated with mobile device 210 (e.g., memory 510).

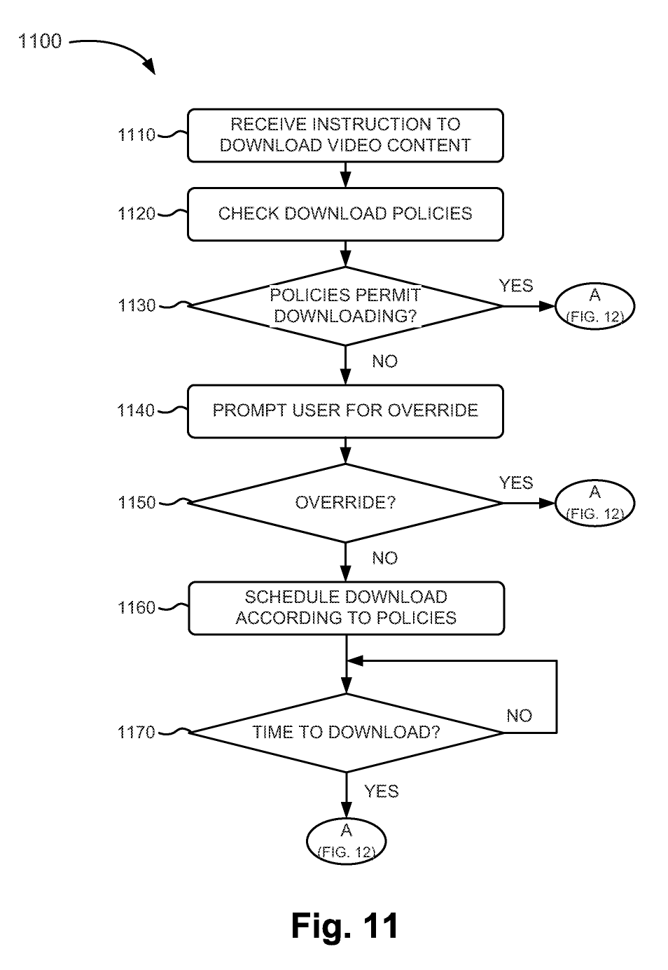

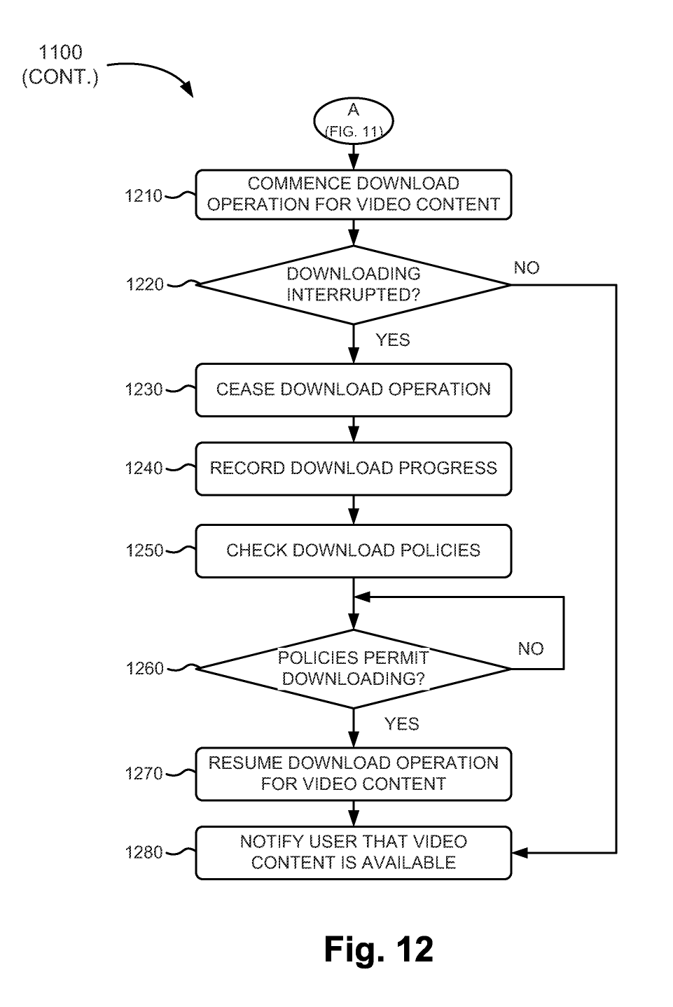

As described above, download manager 620 (FIG. 6) may perform the download operation based on a set of download policies. The download operation will be described in more detail with regard to FIGS. 11 and 12. In some instances, the set of download policies may dictate that the download operation will be scheduled for a later point in time. In these instances, the video content application may notify the user that the download operation is scheduled for a later time, and permit the user to commence the download operation immediately or change the download policies, as shown in FIG. 9D.

As further shown in FIG. 8, a license for the particular video content may be obtained (block 870). For example, the video content application may interact with license server 240, in a secure manner, to obtain a license for the particular video content. In one implementation, the video content application may transmit the license identifier, to license server 240, to identify the particular license that is desired. License server 240 may interact with app server 220 to identify the particular video content for which there has been a purchase, rental, subscription, and to receive user profile information associated with the user of mobile device 210. License server 240 may also interact with the video content application to authenticate the user, device, or application in a manner similar to that described above with regard to block 840. In one implementation, license server 240 may use digital rights management techniques to control access, via a license, to the particular video content. The license may include information regarding use of the particular video content by the user (e.g., whether the user has permanent use (via a purchase) or temporary use (via a rental or subscription)), and a decryption key to permit the encrypted particular video content to be decrypted by mobile device 210.

The particular video content may be made available to the user (block 880). For example, the video content application may use the decryption key (included in/with the license from license server 240) to decrypt the encrypted particular video content. The video content application may then notify the user that the particular video content is available for viewing whenever the user desires.

Reference has been made above to certain operations being performed by the video content application. It should be understood that these operations may actually be performed by processing unit 505 executing the video content application.

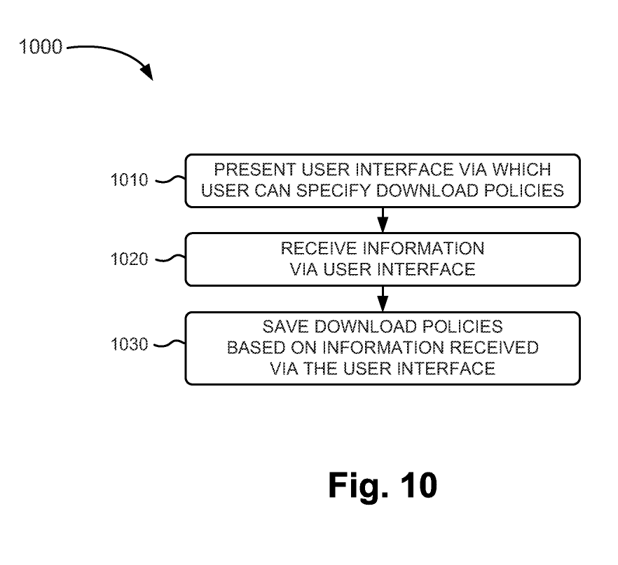

FIG. 10 is a flowchart of an example process 1000 for specifying download policies. In one implementation, process 1000 may be performed by one or more components of mobile device 210, such as processing unit 505 of mobile device 210. In another implementation, one or more blocks of process 1000 may be performed by one or more components of another device (e.g., app server 220 or user profile server 230), or a group of devices including or excluding mobile device 210.

Process 1000 may include presenting a user interface via which a user can specify download policies (block 1010). For example, policy manager 610 may present the user with a user interface, similar to user interface 700 (FIG. 7). The user interface may permit the user to specify a network restriction, a time restriction, an event restriction, a location restriction, or a combination of two or more of these restrictions. Each of these restrictions have been described in detail above.

Information may be received via the user interface (block 1020). For example, policy manager 610 may receive user input, via the user interface, which may specify the set of download policies. For example, the user might select a network restriction, a time restriction, an event restriction, a location restriction, or a combination of restrictions to be used for the set of download policies.

Download policies may be saved based on the information received via the user interface (block 1030). For example, policy manager 610 may store the set of download policies in a memory, such as memory 510. The set of download policies may then be made available for use by download manager 620.

FIGS. 11 and 12 illustrate a flowchart of an example process 1100 for downloading video content. In one implementation, process 1100 may be performed by one or more components of mobile device 210, such as processing unit 505 of mobile device 210. In another implementation, one or more blocks of process 1100 may be performed by one or more components of another device (e.g., content distribution server 260), or a group of devices including or excluding mobile device 210.

Process 1100 may include receiving an instruction to download video content (block 1110) (FIG. 11). As described above with regard to FIG. 9A, a user may be presented with different ways to locate video content of interest. As shown in FIG. 9A, the user may be presented with a list of “featured” video content. The user may select video content from the list and may then be presented with a details user interface, as shown in FIG. 9B. Assume, for example, that the user chooses to purchase the video content by selecting the purchase option in FIG. 9B. As shown in FIG. 9C, the user may be prompted for login information and billing information. Once the user provides this information and the user is properly authenticated, the user may be permitted to download the video content.

The download policies may be checked (block 1120) to determine whether the download policies permit the video content to be downloaded right away (block 1130). For example, download manager 620 may determine whether current conditions permit the video content to be downloaded immediately. If the set of download policies indicate that video content is to be downloaded using WLAN during a specified time period when mobile device 210 has been idle for a specified amount of time, then download manager 620 may determine whether WLAN is available, whether the current time falls within the specified time period, and whether mobile device 210 is idle and has been idle for the specified amount of time. When all of these conditions are met, download manager 620 may determine that the video content can be downloaded immediately (block 1130—YES). If any of these conditions are not met, download manager 620 may determine that the video content cannot be downloaded immediately (block 1130—NO).

If the video content cannot be downloaded immediately according to the download policies (block 1130—NO), the user may be prompted for an override (block 1140). For example, download manager 620 may notify the user that, according to the download policies, the video content is not scheduled to be downloaded immediately, as shown, for example, in FIG. 9D. Download manager 620 may prompt the user whether the user desires to override the download policies or change the download policies, as also shown in FIG. 9D.

If the user chooses not to override the download policies (block 1150—NO), then the video content download may be scheduled according to the download policies (block 1160). For example, download manager 620 may schedule the video content download for a later time and monitor conditions to determine when that time has occurred. For example, if the download policies indicate that video content downloads are only to occur when mobile device 210 is located at home, then download manager 620 may monitor the geographic location of mobile device 210 to determine when mobile device 210 is located within the geographic location designated as the user's home.

It may be determined whether it is time to download the video content (block 1170). As described above with regard to block 1160, download manager 620 may monitor conditions to determine when it is time to commence the download operation. If it is not currently time to commence the download operation (block 1170—NO), then download manager 620 may continue to monitor conditions until it is time to commence the download operation.

If the download policies permit immediate downloading (block 1130—YES), if the user has provided an override of a later downloading (block 1150—YES), or if conditions indicate that it is time to download (block 1170—YES), then a download operation for the video content may be commenced (block 1210) (FIG. 12). For example, download manager 620 may communicate with content distribution server 260 to download the video content. In one implementation, the communication between download manager 620 and content distribution server 260 may conform to FTP. Download manager 620 may store the downloaded video content in a memory, such as memory 510.

If the downloading of the video content is interrupted (block 1220—YES), then the download operation may cease (block 1230). For example, download manager 620 may stop the download operation in certain circumstances, such as when directed by the user or when mobile device 210 commences an operation that uses the communication channel (e.g., when the user uses mobile device 210 for a telephone call, to access the Internet, to make a data transfer, etc.).

The download progress may be recorded (block 1240). For example, download manager 620 may monitor the progress of the download operation and, when the download operation is interrupted, download manager 620 may record the progress for use when the download operation resumes. Download manager 620 may also store the portion of the video content that had been received prior to the interruption.

The download policies may be checked (block 1250). Once the download operation has ceased (due to interruption of the download operation), download manager 620 may monitor conditions, against the download policies, as described above with regard to blocks 1160 and 1170, to determine when to resume the download operation (block 1260). If it is not currently time to resume the download operation (block 1260—NO), then download manager 620 may continue to monitor conditions until it is time to resume the download operation.

If conditions indicate that it is time to resume the download operation (block 1260—YES), then the download operation for the video content may be resumed (block 1270). For example, download manager 620 may communicate with content distribution server 260 to resume the downloading of the video content at where the previous download operation ceased. In one implementation, as described above, the communication between download manager 620 and content distribution server 260 may conform to FTP. Download manager 620 may store the downloaded video content in a memory, such as memory 510.

If the download operation is not interrupted (block 1220—NO) or once the download operation completes, the user may be notified that the video content is available (block 1280). For example, download manager 620 may present a visual notification on display 425 or an audible notification via speaker 415 to inform the user that the video content is available. The user may, thereafter, view the video content whenever the user desires.

An implementation, described herein, may permit a user to generate a set of download policies that may be used to determine how and when to download content to a mobile device. The download policies may improve use of bandwidth and reduce user wait time to obtain desired video content.

The foregoing description provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 8 and 10-12, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
storing, in a memory associated with a mobile device, a set of download policies, where the set of download policies include at least one of: a network restriction policy relating to a type of network connection for a download operation, a time restriction policy relating to a time at which to commence a download operation, an event restriction policy relating to an occurrence of a particular event before commencing a download operation, or a location restriction policy relating to a particular geographic location or geographic region for a download operation;
receiving, by a processor of the mobile device, an instruction to download particular content;
determining, by a processor of the mobile device and after receiving the instruction, that the set of download policies permits the particular content to be downloaded;
downloading, by a processor of the mobile device, the particular content when the set of download policies permits the particular content to be downloaded;
obtaining, by a processor of the mobile device and in response to downloading the particular content, a license for the particular content; and
providing, by a processor of the mobile device and after obtaining the license, a notification that the particular content is available.

2. The method of claim 1, further comprising:
presenting, via a display associated with the mobile device, a user interface via which a user can specify the set of download policies, where the user interface includes information regarding the network restriction policy, the time restriction policy, the event restriction policy, and the location restriction policy; and
receiving, from the user and via the user interface, input defining the set of download policies via the user interface.

3. The method of claim 1, where receiving the instruction to download particular content includes:
presenting, via a display associated with the mobile device, a user interface via which a user can select content, and
receiving, from the user and via the user interface, selection of the particular content.

4. The method of claim 1, where the particular content is encrypted, and the license includes a decryption key, and
where the method further comprises decrypting the particular content using the decryption key.

5. The method of claim 1, further comprising:
determining that the set of download policies does not permit the particular content to be downloaded immediately after receiving the instruction;
providing a user with an option to override the set of download policies when the set of download policies does not permit the particular content to be downloaded immediately after receiving the instruction;
receiving, from the user, selection of the option to override the set of download policies; and
downloading the particular content in response to receiving selection of the option to override the set of download policies.

6. The method of claim 1, where determining that the set of download policies permits the particular content to be downloaded includes:
determining that the set of download policies initially does not permit the particular content to be downloaded after receiving the instruction, and
monitoring conditions to identify an instance when the conditions satisfy the set of download policies.

7. The method of claim 1, further comprising:
receiving interruption of the downloading of the particular content when only a portion of the particular content has been received, where the portion is less than an entirety of the particular content;
ceasing the downloading of the particular content in response to the interruption;
storing the portion of the particular content;
recording information regarding a progress of the downloading of the particular content at a time of ceasing the downloading; and
resuming, after storing the portion, the downloading of the particular content based on the recorded information.

8. The method of claim 1, where providing the notification that the particular content is available includes:
presenting a visual notification via a display associated with the mobile device, or
presenting an audible notification via a speaker associated with the mobile device.

9. The method of claim 1, further comprising:
authenticating a user, the mobile device, or an application residing on the mobile device prior to permitting the particular content to be downloaded to the mobile device.

10. The method of claim 9, where authenticating the user, the mobile device, or the application includes at least one of:
receiving login information associated with the user, and comparing the login information with stored information to authenticate the user,
receiving device information associated with the mobile device, and comparing the device information with stored information to authenticate the mobile device, or
receiving application information associated with the application, and comparing the application information with stored information to authenticate the application.

11. A mobile device, comprising:
a memory to store a set of download policies, where the set of download policies include one or more of: a network restriction policy relating to a type of network connection for a download operation, a time restriction policy relating to a time at which to commence a download operation, an event restriction policy relating to an occurrence of a particular event before commencing a download operation, or a location restriction policy relating to a particular geographic location or geographic region for a download operation; and
a processor, connected to the memory, to:
receive, from a user, information that defines the set of download policies,
receive an instruction to download particular video content,
determine, after receiving the instruction, that the set of download policies permits the particular video content to be downloaded,
download the particular video content when the set of download policies permits the particular video content to be downloaded,
obtain, in response to downloading the particular video content, license information for the particular video content, and
make the particular video content available for access by the user after obtaining the license.

12. The mobile device of claim 11, where, when receiving information that defines the set of download policies, the processor is to:
present, via a display associated with the mobile device, a user interface via which the user can specify the set of download policies, where the user interface includes information regarding the network restriction policy, the time restriction policy, the event restriction policy, and the location restriction policy, and
receive, from the user and via the user interface, input defining the set of download policies.

13. The mobile device of claim 11, where, when receiving the instruction to download particular video content, the processor is to:
present, via a display associated with the mobile device, a user interface via which the user can select video content, and
receive, from the user and via the user interface, selection of the particular video content.

14. The mobile device of claim 11, where the particular video content is encrypted video content, and the license information includes a decryption key, and
where the processor is further to decrypt the encrypted video content using the decryption key.

15. The mobile device of claim 11, where the license information includes information that defines a length of time that the particular video content is accessible by the user, and
where, when making the particular video content available, the processor is to permit the user to access the particular video content for the length of time.

16. The mobile device of claim 11, where the processor is further to:
determine that the set of download policies does not permit the particular video content to be downloaded immediately after receiving the instruction,
provide the user with an option to override the set of download policies when the set of download policies does not permit the particular video content to be downloaded immediately after receiving the instruction,
receive, from the user, selection of the option to override the set of download policies, and
download the particular video content in response to receiving selection of the option to override the set of download policies.

17. The mobile device of claim 11, where, when determining that the set of download policies permits the particular content to be downloaded, the processor is to:
determine that the set of download policies initially does not permit the particular video content to be downloaded after receiving the instruction, and
monitor conditions to identify an instance when the conditions satisfy the set of download policies.

18. The mobile device of claim 11, where the processor is further to:
receive interruption of the downloading of the particular video content when only a portion of the particular video content has been received, where the portion is less than an entirety of the particular video content,
cease the downloading of the particular video content in response to the interruption,
store the portion of the particular video content,
record information regarding a progress of the downloading of the particular video content at a time of ceasing the downloading, and
resume, after storing the portion of the particular video content, the downloading of the particular video content based on the recorded information.

19. The mobile device of claim 11, where the instruction includes an instruction to rent the particular video content, an instruction to purchase the particular video content, or an instruction to subscribe to a service via which the particular video content is available.

20. A non-transitory computer-readable medium that stores instructions executable by a processor, of a device, to perform a method, the method comprising:
receiving input to define one or more download policies from a plurality of available download policies, where the plurality of available download policies include:
one or more network restriction policies, where each of the one or more network restriction policies relates to a type of network connection for a download operation,
one or more time restriction policies, where each of the one or more time restriction policies relates to a time at which to commence a download operation,
one or more event restriction policies, where each of the one or more event restriction policies relates to an occurrence of a particular event before commencing a download operation, and
one or more location restriction policies, where each of the one or more location restriction policies relates to a particular geographic location or geographic region for a download operation;
receiving an instruction to download particular content;
determining, after receiving the instruction, that the one or more download policies permit the particular content to be downloaded;
downloading the particular content when the one or more download policies permit the particular content to be downloaded; and
generating, after downloading the particular content, a notification that the particular content is available to be accessed.

21. The computer-readable medium of claim 20, where the method further comprises:
authenticating a user, the device, or an application residing on the device prior to permitting the particular content to be downloaded, where authenticating the user, the device, or the application includes at least one of:
receiving login information associated with the user, and comparing the login information with stored information to authenticate the user,
receiving device information associated with the device, and comparing the device information with stored information to authenticate the device, or
receiving application information associated with the application, and comparing the application information with stored information to authenticate the application.

22. The computer-readable medium of claim 20, where the method further comprises:
determining that the one or more download policies do not permit the particular content to be downloaded immediately after receiving the instruction;
providing a user with an option to override the one or more download policies when the one or more download policies do not permit the particular content to be downloaded immediately after receiving the instruction;
receiving, from the user, selection of the option to override the one or more download policies; and
downloading the particular content in response to receiving selection of the option to override the one or more download policies.

23. The computer-readable medium of claim 20, where determining that the one or more download policies permit the particular content to be downloaded includes:
determining that the one or more download policies initially do not permit the particular content to be downloaded after receiving the instruction, and
monitoring conditions to identify an instance when the conditions satisfy the one or more download policies.

24. The computer-readable medium of claim 20, where the method further comprises:
receiving interruption of the downloading of the particular content when only a portion of the particular content has been received, where the portion is less than an entirety of the particular content;
ceasing the downloading of the particular content in response to the interruption;
storing the portion of the particular content;
recording information regarding a progress of the downloading of the particular content at a time of ceasing the downloading; and
resuming, after storing the portion, the downloading of the particular content based on the recorded information.
